(19) United States
(12) Patent Application Publication
(10) Pub. No.: US 2026/0088337 A1
(43) Pub. Date: Mar. 26, 2026

(54) SOLID ELECTROLYTE MATERIAL AND BATTERY

(71) Applicant: TOYOTA JIDOSHA KABUSHIKI KAISHA, Toyota-shi (JP)

(72) Inventor: Azusa NAKANISHI, Susono-shi (JP)

(73) Assignee: TOYOTA JIDOSHA KABUSHIKI KAISHA, Toyota-shi (JP)

(21) Appl. No.: 19/210,052

(22) Filed: May 16, 2025

(30) Foreign Application Priority Data
Sep. 24, 2024 (JP) 2024-164829

(51) Int. Cl. H01M 10/0525; H01M 10/0562

(52) U.S. Cl. CPC H01M 10/0525; H01M 10/0562; H01M 2300/0068

(57) ABSTRACT

A solid electrolyte material contains an Li salt that has a fluorine-containing anion, an in organic filler, and a polymer. The inorganic filler has a surface modified with a fluorinated alkyl. The solid electrolyte material further includes succinonitrile. The inorganic filler contains at least one selected from the group consisting of SiO2, TiO2, ZrO2, and MgO; and the fluorinated alkyl contains at least one of a 1H, 1H, 2H, 2H-tridecafluoro-n-octyl group and a 1H, 1H, 2H, 2H-heptadecafluorodecyl group.

### CROSS-REFERENCE TO RELATED APPLICATION

This application claims priority to Japanese Patent Application No. 2024-164829 filed on Sep. 24, 2024. The disclosure of the above-identified application, including the specification, drawings, and claims, is incorporated by reference herein in its entirety.

### BACKGROUND

### 1. Technical Field

The disclosure relates to a solid electrolyte material and a battery.

### 2. Description of Related Art

Various technologies for solid electrolyte materials such as one disclosed in Japanese Unexamined Patent Application Publication No. 2011-081934 (JP 2011-081934 A) have been proposed.

### SUMMARY

JP 2011-081934 A discloses a solid electrolyte containing an ionic liquid, a compound having a function of including an anion, an electrolyte salt, and an inorganic filler (inorganic compound particles) to provide a solid electrolyte having a high lithium ionic transport number and excellent safety, durability, and cyclability. JP 2011-081934 A states that the compound having a function of including an anion coordinates to an anion of the electrolyte salt, which develops the effect of improving a lithium ionic transport number.

In JP 2011-081934 A, the solid electrolyte is prepared by mixing these components, and therefore it is difficult to uniformly disperse the compound having a function of including an anion throughout the inorganic filler. This causes such a problem that it is difficult to obtain the effect of improving a lithium ionic transport number.

In light of the above circumstances, it is a main object of the disclosure to provide a solid electrolyte material excellent in lithium ionic transport number.

Specifically, the disclosure includes the following aspects.

<1> A first aspect of the disclosure relates to a solid electrolyte material containing an Li salt having a fluorine-containing anion, an inorganic filler, and a polymer. The inorganic filler has a surface modified with a fluorinated alkyl.

<2> The solid electrolyte material according to the first aspect may further contain succinonitrile.

<3> In the solid electrolyte material according to the first aspect or the second aspect, the inorganic filler may contain at least one selected from the group consisting of SiO₂, TiO₂, ZrO₂, and MgO, and the fluorinated alkyl may contain at least one of a 1H, 1H, 2H, 2H-tridecafluoro-n-octyl group and a 1H, 1H, 2H, 2H-heptadecafluorodecyl group.

<4> In the solid electrolyte material according to any one of the first to third aspects, the Li salt may contain at least one selected from the group consisting of lithium bis(fluorosulfonyl)imide (LiFSI), lithium bis(trifluoromethanesulfonyl)imide (LiTFSI), lithium bis(pentafluoroethanesulfonyl)imide (LiBETI), lithium fluorosulfonyl(trifluoromethanesulfonyl)imide (LIFTFSI), LiPF₆, LiBF₄, and LiCF₃SO₃ (LiTfO).

<5> A fifth aspect of the disclosure relates to a battery including a positive electrode layer, a negative electrode layer, and an electrolyte layer. The electrolyte layer contains a solid electrolyte. The solid electrolyte is the solid electrolyte material according to any one of the first to fourth aspects.

The disclosure makes it possible to obtain a solid electrolyte material excellent in lithium ionic transport number.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view of an example of a battery according to the disclosure.

### DETAILED DESCRIPTION OF EMBODIMENTS

Hereinbelow, embodiments according to the disclosure will be described. It should be noted that matters that are not particularly referred to herein and that are necessary for implementing the disclosure (e.g., general configurations and production processes of solid electrolyte materials which do not characterize the disclosure) can be understood as design matters for those skilled in the art based on the related art in the field. The disclosure can be implemented based on the contents disclosed herein and common technical knowledge in the field.

Unless otherwise specified, the average particle diameter of particles herein refers to a value of median diameter (D50) which is a particle diameter at a cumulative percentage of 50% in a volume-based particle size distribution measured by laser diffraction/scattering particle size distribution measurement.

### A. Solid Electrolyte Material

The disclosure provides a solid electrolyte material containing a Li salt having a fluorine-containing anion, an inorganic filler, and a polymer, and the inorganic filler has a surface modified with a fluorinated alkyl.

In a solid electrolyte material containing an Li salt having a fluorine-containing anion (hereinafter sometimes referred to as F-containing anion), an inorganic filler, and a polymer, both lithium ions (cations) and F-containing anions move, which reduces a lithium ionic transport number.

For this reason, the solid electrolyte material according to the disclosure uses an inorganic filler having a surface modified with a fluorinated alkyl, which successfully improves a lithium ionic transport number. The reason for this is considered to be that surface modification with a fluorinated alkyl induces F-F interaction between the inorganic filler and F-containing anions, which makes the mobility of F-containing anions relatively lower than that of lithium ions. Another reason is considered to be that a fluorinated alkyl is previously introduced into the surface of the inorganic filler by surface modification, which makes it possible to enhance dispersibility of the inorganic filler and the fluorinated alkyl even in the solid electrolyte material.

The Li salt having an F-containing anion is not limited. For example, at least one selected from the group consisting of lithium bis(fluorosulfonyl)imide (LiFSI), lithium bis(trifluoromethanesulfonyl)imide (LiTFSI), lithium bis(pentafluoroethanesulfonyl)imide (LiBETI), lithium fluorosulfonyl(trifluoromethanesulfonyl)imide (LiFTFSI), LiPF₆, LiBF₄, and LiCF₃SO₃ (LiTfO) may be contained.

The content of the Li salt having an F-containing anion in the solid electrolyte material is not limited and may be, for example, 40% by mass or more or 60% by mass or more and 96% by mass or less or 85% by mass or less relative to the total mass of the solid electrolyte material.

Examples of the inorganic filler include SiO₂, Al₂O₃, TiO₂, ZrO₂, and MgO, and at least ones selected from the group consisting of SiO₂, TiO₂, ZrO₂, and MgO may be contained.

The average particle diameter of the inorganic filler is not limited and may be, for example, 0.1 μm to 0.2 μm.

The inorganic filler has a surface modified with a fluorinated alkyl.

Introduction of a fluorinated alkyl into the surface of the inorganic filler induces F-F interaction between the inorganic filler and F-containing anions and makes it possible to enhance dispersibility of the inorganic filler and the fluorinated alkyl in the solid electrolyte material.

In the disclosure, the fluorinated alkyl is not limited as long as it has a structure such that some or all of hydrogen atoms in an alkyl carbon chain are substituted with fluorine atoms, and may have a group, an element, or the like other than a fluorinated alkyl group. The number of carbon atoms of the alkyl carbon chain in the fluorinated alkyl is not limited and may be, for example, 1 to 12 or 3 to 10. The fluorinated alkyl may have a branched structure.

A specific example of the fluorinated alkyl is a structure containing at least one of a 1H, 1H, 2H, 2H-tridecafluoro-n-octyl group and a 1H, 1H, 2H, 2H-heptadecafluorodecyl group.

A method for modifying the surface of the inorganic filler with a fluorinated alkyl is not limited and may be, for example, surface treatment of the inorganic filler with a silane coupling agent. The surface treatment with a silane coupling agent can be performed by a publicly-known method.

Trimethoxy (1H, 1H, 2H, 2H-tridecafluoro-n-octyl) silane represented by the following structural formula (1) can be used as a silane coupling agent and can introduce a modification group containing a 1H, 1H, 2H, 2H-tridecafluoro-n-octyl group into the surface of the inorganic filler. Similarly, trimethoxy (1H, 1H, 2H, 2H-heptadecafluorodecyl) silane represented by the following structural formula (2) can introduce a modification group containing a 1H, 1H, 2H, 2H-heptadecafluorodecyl group into the surface of the inorganic filler.

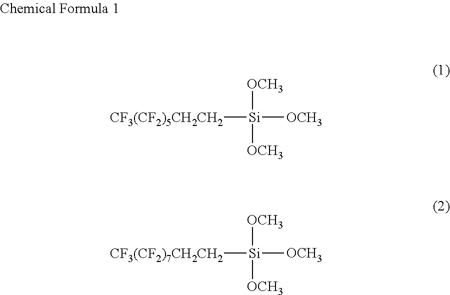

The content of the inorganic filler having a surface modified with a fluorinated alkyl in the solid electrolyte material may be, for example, 1% by mass or more and 10% by mass or less relative to the total mass of the solid electrolyte material.

Examples of the polymer include polyvinylidene fluoride, polyethylene oxide, polypropylene oxide, polyacrylonitrile, polymethacrylonitrile, polyvinyl butyral, polyvinyl formal, polyvinyl pyrrolidone, styrene butadiene rubber, nitrile butadiene rubber, and a combination of two or more of them.

The number-average molecular weight Mn of the polymer is not limited and may be 3000 to 200000 or 5000 to 100000.

The content of the polymer in the solid electrolyte material may be 3% by mass or more and 30% by mass or less or 10% by mass or less relative to the total mass of the solid electrolyte material. If the content of the polymer is less than 3% by mass, there is a case where the solid electrolyte material cannot have desired strength. If the content of the polymer exceeds 30% by mass, there is a case where a reduction in ionic transport number occurs.

The use of the polymer for the solid electrolyte material makes it possible to improve a lithium ionic transport number and allows the solid electrolyte material to function as a separator.

The solid electrolyte material according to the disclosure may contain a component other than the components described above. The another component may be, for example, succinonitrile (hereinafter sometimes referred to as SN). Succinonitrile is a plastic crystal present as NCCH₂CH₂CN and can be used as a solid solvent to increase the ion conductivity of the solid electrolyte material. From the viewpoint of increasing the ion conductivity of the solid electrolyte material, the content of succinonitrile in the solid electrolyte material is, for example, 1 mol to 10 mol and may be 2 mol to 4 mol per mole of the Li salt having an F-containing anion.

### B. Battery

A battery according to the disclosure includes a positive electrode layer, a negative electrode layer, and an electrolyte layer and usually includes a positive electrode including a positive electrode layer and a negative electrode including a negative electrode layer.

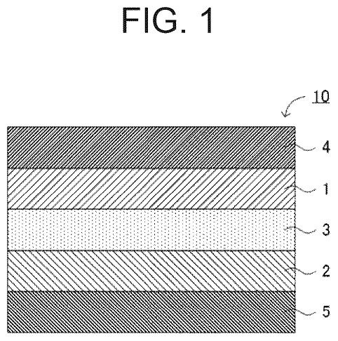

FIG. 1 is a schematic sectional view of an example of the battery according to the disclosure. A battery 10 shown in FIG. 1 includes a positive electrode layer 1, a negative electrode layer 2, an electrolyte layer 3 disposed between the positive electrode layer 1 and the negative electrode layer 2, a positive electrode current collector 4 that collects electric current from the positive electrode layer 1, and a negative electrode current collector 5 that collects electric current from the negative electrode layer 2. In the disclosure, the electrolyte layer 3 contains the solid electrolyte material described above in “A. Solid Electrolyte Material”.

The use of the solid electrolyte material according to the disclosure makes it possible to obtain a battery excellent in lithium ion conductivity.

The battery according to the disclosure may be a solid-state battery including an electrolyte layer containing a solid electrolyte. The solid-state battery may be either a semi-solid-state battery or an all-solid-state battery. In the disclosure, the semi-solid-state battery refers to a battery including an electrolyte layer containing a solid electrolyte and a liquid component (e.g., a solvent and an electrolytic solution or the like). In the disclosure, the all-solid-state battery refers to a battery including an electrolyte layer containing only a solid electrolyte as an electrolyte.

### Positive Electrode

The positive electrode includes a positive electrode layer and, if necessary, further includes a positive electrode current collector.

The positive electrode layer is a layer containing at least a positive electrode active material. If necessary, the positive electrode layer may contain at least one of a solid electrolyte, a conductive material, and a binder.

The positive electrode active material may be, for example, an oxide active material. Examples of the oxide active material include layered rock-salt-type active materials such as LiCoO₂, LiMnO₂, LiNiO₂, LiVO₂, and LiNi₁CO_{1/3}Mn_{1/3}O₂, spinel-type active materials such as LiMn₂O₄, Li₄Ti₅O₁₂, and Li(Ni_{0.5}Mn_{1.5})O₄, and olivine-type active materials such as LiFePO₄, LiMnPO₄, LiNiPO₄, and LiCoPO₄.

On the surface of the positive electrode active material, a coating layer containing an Li ion conductive compound may be provided. This is because a reaction between the positive electrode active material and a solid electrolyte (especially, a sulfide solid electrolyte) can be inhibited. Examples of the Li ion conductive compound include B₂O₃, Li₂B₄O₇, LiBPO₄, Li₃PO₄, LiPO₃, and LiNbO₃. The thickness of the coating layer is, for example, 1 nm or more and 30 nm or less. The surface coverage of the positive electrode active material with the Li ion conductive compound is, for example, 70% or more and may be 90% or more or 100%. A method for coating the surface of the positive electrode active material with the Li ion conductive compound is not limited, and an appropriate conventionally-known method can be employed.

The positive electrode active material usually has a particulate form. Particles of the positive electrode active material may be primary particles or secondary particles formed by agglomeration of primary particles.

The average particle diameter (D50) of the positive electrode active material is not limited and is, for example, 0.01 μm or more and 50 μm or less and may be 0.5 μm or more and 30 μm or less.

The content of the positive electrode active material in the positive electrode layer is, for example, 20% by mass or more and may be 30% by mass or more or 40% by mass or more. If the content of the positive electrode active material is too low, there is a possibility that a sufficient energy density cannot be achieved. On the other hand, the content of the positive electrode active material in the positive electrode layer is, for example, 80% by mass or less and may be 70% by mass or less or 60% by mass or less. If the content of the positive electrode active material is too high, there is a possibility that ion conductivity and electron conductivity of the positive electrode layer are relatively reduced.

The positive electrode layer may contain a solid electrolyte. Addition of a solid electrolyte improves the ion conductivity of the positive electrode layer. The solid electrolyte may be an inorganic solid electrolyte such as a sulfide solid electrolyte, a halide solid electrolyte, an oxide solid electrolyte, or a complex hydride solid electrolyte or an organic solid electrolyte such as a gel electrolyte. The solid electrolyte may be the solid electrolyte material described above in “A. Solid Electrolyte Material”.

The sulfide solid electrolyte is an electrolyte containing an S element. The sulfide solid electrolyte usually contains at least an Li element and an S element. The sulfide solid electrolyte may further contain an Me element (Me is at least one of P, As, Sb, Si, Ge, Sn, Bi, Al, Zn, Ga, and In). The sulfide solid electrolyte may contain a halogen element such as F, Cl, Br, or I.

The sulfide solid electrolyte may be a glass-type (amorphous) sulfide solid electrolyte, a glass ceramic-type sulfide solid electrolyte, or a crystalline sulfide solid electrolyte. The sulfide solid electrolyte may have a crystal phase. Examples of the crystal phase include a Thio-LISICON-type crystal phase, an argyrodite-type crystal phase, and an LGPS-type crystal phase.

The composition of the sulfide solid electrolyte is not limited and examples thereof include xLi₂S·(1-x)P₂S₅ (0.5≤x<1) and yLiI·zLiBr·(100-y-z)(xLi₂S·(1-x)P₂S₅) (0.5≤x<1, 0≤y≤30, 0≤z≤30). In these compositions, x may satisfy 0.7≤x≤0.8. Another example of the composition of the sulfide solid electrolyte is Li₇₋ₓPS₆₋ₓXₓ. X is at least one of F, Cl, Br, and I, and x satisfies 0 x<2. Yet another example of the composition of the sulfide solid electrolyte is Li₄₋ₓMe₁₋ₓPₓS₄ (0<x<1). Me is defined as described above. Examples of the sulfide solid electrolyte include LiI—LiBr—Li₂S—P₂S₅, LiI—Li₂S—P₂S₅, LiI—Li₂S—P₂O₅, and LiI—Li₃PO₄—P₂S₅.

The oxide solid electrolyte may be, for example, a material having a garnet-type crystal structure containing an Li element, an La element, an A element (A is at least one of Zr, Nb, Ta, and Al), and an O element. Examples of the oxide solid electrolyte include Li₂O—B₂O₃—P₂O₅, Li₂O—SiO₂, Li₂O—B₂O₃, Li_{1.3}Al_{0.3}Ti_{0.7}(PO₄)₃, Li₅La₃Ta₂O₁₂, Li₇La₃Zr₂O₁₂, Li₆BaLa₂ Ta₂O₁₂, Li_{3.6}Si_{0.6}P_{0.4}O₄, Li₄SiO₄, Li₃PO₄, and Li₃₊ₓPO₄₋ₓNₓ (1≤x≤3).

The halide solid electrolyte may be, for example, a solid electrolyte containing Li, M and X (M is at least one of Ti, Al, and Y and X is F, Cl, or Br).

From the viewpoint of ease of handling, the solid electrolyte may have a particulate form.

The average particle diameter (D50) of particles of the solid electrolyte is not limited and may be 1 nm to 100 μm.

The content of the solid electrolyte in the positive electrode layer is, for example, 10% by mass or more and may be 20% by mass or more or 30% by mass or more. If the content of the solid electrolyte is too low, there is a possibility that the positive electrode layer is poor in ion conduction path. On the other hand, the content of the solid electrolyte in the positive electrode layer is, for example 60% by mass or less and may be 50% by mass or less. If the content of the solid electrolyte is too high, there is a possibility that the content of the positive electrode active material is relatively reduced, thereby reducing an energy density.

The positive electrode layer may contain a conductive material. Addition of a conductive material improves the electron conductivity of the positive electrode layer. Examples of the conductive material include a carbon material, metallic particles, and a conductive polymer. Examples of the carbon material include particulate carbon materials such as acetylene black (AB) and ketchen black (KB) and fibrous carbon materials such as vapor grown carbon fibers (VGCFs), carbon nanotubes (CNTs), and carbon nanofibers (CNFs).

The content of the conductive material in the positive electrode layer is, for example, 0.1% by mass or more and may be 0.5% by mass or more or 1.0% by mass or more. If the content of the conductive material is too low, there is a possibility that the positive electrode layer is poor in electron conduction path. On the other hand, the content of the conductive material in the positive electrode layer is, for example, 5% by mass or less and may be 3% by mass or less. If the content of the conductive material is too high, there is a possibility that the content of the positive electrode active material is relatively reduced, thereby reducing an energy density.

The positive electrode layer may contain a binder. Examples of the binder include styrene-butadiene rubber (SBR), acrylonitrile-butadiene rubber (NBR), butadiene rubber (BR), polyvinylidene fluoride (PVDF), polytetrafluoroethylene (PTFE), a styrene-isoprene-styrene block copolymer (SIS), and an ethylene-propylene-diene copolymer (EPDM).

The content of the binder in the positive electrode layer may be, for example, 0.5% by mass or more, 1.0% by mass or more, or 1.5% by mass or more. If the content of the binder is too low, there is a possibility that a resistance increase due to charge and discharge cannot sufficiently be reduced. On the other hand, the content of the binder in the positive electrode layer is, for example, 5% by mass or less and may be 3% by mass or less.

If the content of the binder is too high, there is a possibility that the content of the positive electrode active material is relatively reduced, thereby reducing an energy density.

The thickness of the positive electrode layer is, for example, 0.1 μm or more and 1000 μm or less and may be 1 μm or more and 500 μm or less or 30 μm or more and 100 μm or less.

A method for producing the positive electrode layer is not limited and may be, for example, a method in which the positive electrode active material described above, the solid electrolyte described above, and a solvent are mixed to obtain a positive electrode slurry, and the positive electrode slurry is applied onto a positive electrode current collector and dried to form a positive electrode layer. When the positive electrode layer is formed, press processing may be performed to press the positive electrode layer in its thickness direction. Examples of the press processing include roller pressing and flat-plate pressing.

Examples of the solvent include tetralin, di-isobutyl ketone, butyl butyrate, mesitylene, heptane, dibutyl ether, decane, dodecane, isodecane, and toluene, and two or more components of them may be contained.

Examples of a material of the positive electrode current collector include SUS, Cr, Au, Pt, Zn, aluminum, copper, nickel, iron, titanium, and carbon. The thickness of the positive electrode current collector is, for example, 0.1 μm or more and 100 μm or less. The form of the positive electrode current collector may be a foil, a plate, or the like. The plan-view shape of the positive electrode current collector is not limited and may be, for example, a circle, an ellipse, a rectangle, or any polygonal shape. The positive electrode current collector may be configured to have a buffer layer, an elastic layer, or a positive temperature coefficient (PTC) thermistor layer disposed on the surface thereof.

### Negative Electrode

The negative electrode includes a negative electrode layer and, if necessary, further includes a negative electrode current collector.

The negative electrode layer is a layer containing at least a negative electrode active material. If necessary, the negative electrode layer may contain at least one of a solid electrolyte, a conductive material, and a binder. The negative electrode layer contains, as a negative electrode active material, at least one of elemental Li and an Li alloy. Examples of a metal element other than lithium contained in the Li alloy include Mg, Ag, In, Sn, Si, Ga, Au, and Pt.

The solid electrolyte, the conductive material, and the binder used for the negative electrode layer may be the same as those described above with reference to the positive electrode layer.

Examples of a material of the negative electrode current collector include SUS, aluminum, copper, nickel, iron, titanium, and carbon. The thickness of the negative electrode current collector depends on the form of the negative electrode current collector but may be, for example, in the range of 1 μm to 50 μm. The form of the negative electrode current collector may be a foil, a plate, or the like. The plan-view shape of the negative electrode current collector is not limited and examples thereof include a circle, an ellipse, a rectangle, and any polygonal shape. The negative electrode current collector may be configured to have a buffer layer, an elastic layer, or a PTC thermistor layer disposed on the surface thereof.

### Electrolyte Layer

The electrolyte layer is a layer provided between the positive electrode layer and the negative electrode layer and contains at least a solid electrolyte. The solid electrolyte is the solid electrolyte material described above in “A. Solid Electrolyte Material”.

The content of the solid electrolyte in the electrolyte layer is not limited and is, for example, 50% by mass or more and may be 60% by mass or more and 100% by mass or less, 70% by mass or more and 100% by mass or less, or 100% by mass.

As the solid electrolyte, one type of solid electrolyte may be used alone or two or more types of solid electrolytes may be used. When two or more types of solid electrolytes are used, the two or more types of solid electrolytes may be mixed or a multi-layer structure may be formed which has two or more layers respectively formed of the two or more types of solid electrolytes.

The electrolyte layer may further contain, as a solid electrolyte, a solid electrolyte other than the solid electrolyte material described above in “A. Solid Electrolyte Material”. Examples of the solid electrolyte other than the solid electrolyte material described above in “A. Solid Electrolyte Material” include the above-described solid electrolytes that can be contained in the positive electrode layer.

The electrolyte layer may contain an electrolytic solution. When an electrolytic solution is contained, ion conductivity can be improved. From the viewpoint of preventing a reduction in mechanical strength at high temperature, the content of the electrolytic solution in the electrolyte layer may be, for example, less than 10% by mass, 5% by mass or less, 1% by mass or less, or 0.5% by mass or less relative to the total mass of the electrolyte layer.

Examples of the electrolytic solution include aqueous electrolytic solutions and non-aqueous electrolytic solutions. These may be used alone or in combination of two or more of them. The aqueous electrolytic solutions and the non-aqueous electrolytic solutions may be those conventionally known.

The electrolyte layer may be a separator that is impregnated with an electrolyte and prevents contact between the positive electrode layer and the negative electrode layer.

The material of the separator is not limited as long as it is a porous membrane, and examples thereof include resins such as polyethylene (PE), polypropylene (PP), polyester, polyvinyl alcohol, cellulose, and polyamide. Among these, polyethylene and polypropylene are preferred. The separator may have a single-layer structure or a multi-layer structure. Examples of the separator having a multi-layer structure include a separator having a PE/PP two-layer structure or a separator having a PP/PE/PP or PE/PP/PE three-layer structure.

The separator may be a non-woven fabric such as a resin non-woven fabric or a glass-fiber non-woven fabric.

The thickness of the electrolyte layer is, for example, 0.1 μm or more and 1000 μm or less and may be 0.1 μm or more and 500 μm or less or 0.1 μm or more and 100 μm or less.

### Others

The battery according to the disclosure may further include a confining jig that applies a confining pressure to the positive electrode layer, the electrolyte layer, and the negative electrode layer in their thickness direction. When the electrolyte layer is a solid electrolyte layer, excellent ion conduction paths and electron conduction paths can be formed. The confining pressure is, for example, 0.1 MPa or more and may be 1 MPa or more or 5 MPa or more. On the other hand, the confining pressure is, for example, 100 MPa or less and may be 50 MPa or less or 20 MPa or less.

The type of the battery according to the disclosure is not limited, but the battery according to the disclosure is typically a lithium ion battery. The battery according to the disclosure may be a primary battery or a secondary battery. Among these, a secondary battery is preferred. This is because a secondary battery can repeatedly be charged and discharged and is useful as, for example, an in-vehicle battery.

The form of the battery is not limited, and the battery may be of, for example, a coin type, a cylinder type, a rectangle type, a sheet type, a button type, a flat type, or a lamination type.

The battery is used as, for example, an electric power source for a vehicle such as a hybrid electric vehicle (HEV), a plug-in hybrid electric vehicle (PHEV), a battery electric vehicle (BEV), a gasoline-powered vehicle, or a diesel-powered vehicle. Particularly, the battery is preferably used as a driving electric power source for a hybrid electric vehicle (HEV), a plug-in hybrid electric vehicle (PHEV), or a battery electric vehicle (BEV). The battery may also be used as an electric power source for a transport other than a vehicle (e.g., a railway vehicle, a ship, or an aircraft) or as an electric power source for an electric product such as an information processor.

### Example 1

### Production of Surface-modified SiO₂ (1)

In an Ar glovebox, 2 g of SiO₂ (manufactured by Sigma-Aldrich, average particle diameter: 0.1 μm to 0.2 μm), 20 g of super-dehydrated ethanol (manufactured by FUJIFILM Wako Pure Chemical Corporation), and 0.15 g of trimethoxy (1H, 1H, 2H, 2H-tridecafluoro-n-octyl) silane (the above structural formula (1), manufactured by Tokyo Chemical Industry Co., Ltd.) were weighed and stirred in a closed reaction vessel at 50° C. for 16 hours to perform a silane coupling reaction. A resulting solution after reaction with stirring was filtered by suction, and washing with 30 mL of ethanol and filtration were repeated five times. The thus obtained solid was vacuum-dried at 100° C. for 12 hours. In this way, surface-modified SiO₂ (1) was obtained which had a SiO₂ surface modified with a modification group containing a fluorinated alkyl group.

### Production of Solid Electrolyte Material

In a glovebox under an atmosphere of Ar, succinonitrile (manufactured by Sigma-Aldrich) and LITFSI (manufactured by Sigma-Aldrich) were weighed such that a mole ratio between SN and LITFSI was 4:1 and stirred at 70° C. for 24 hours. To the thus obtained solution, polyethylene oxide (manufactured by Sigma-Aldrich, number-average molecular weight Mn=6000) and the surface-modified SiO₂ (1) were added such that the amount of the polyethylene oxide and the amount of the surface-modified SiO₂ (1) were respectively 10% by mass and 5% by mass relative to the total mass of a solid electrolyte material to be obtained, and a resultant was further stirred at 70° C. for 24 hours to obtain a solid electrolyte material.

### Example 2

### Production of Surface-Modified SiO₂ (2)

Surface-modified SiO₂ (2) having a SiO₂ surface modified with a modification group containing a fluorinated alkyl group was obtained in the same manner as in Example 1 except that 0.18 g of trimethoxy (1H, 1H, 2H, 2H-hepatadecafluorodecyl) silane (the above structural formula (2), manufactured by Tokyo Chemical Industry Co., Ltd.) was used instead of 0.15 g of trimethoxy (1H, 1H, 2H, 2H-tridecafluoro-n-octyl) silane.

### Production of Solid Electrolyte Material

A solid electrolyte material was obtained in the same manner as in Example 1 except that the surface-modified SiO₂ (2) was used instead of the surface-modified SiO₂ (1).

### Comparative Example 1

### Production of Solid Electrolyte Material

A solid electrolyte material was obtained in the same manner as in Example 1 except that the surface-modified SiO₂ (1) was not used.

### Comparative Example 2

### Production of Solid Electrolyte Material

A solid electrolyte material was obtained in the same manner as in Example 1 except that non-surface-modified SiO₂ (manufactured by Sigma-Aldrich, average particle diameter: 0.1 μm to 0.2 μm) was used instead of the surface-modified SiO₂ (1).

### Comparative Example 3

### Production of Surface Modified SiO₂ (3)

Surface-modified SiO₂ (3) having a SiO₂ surface modified with a modification group containing a non-fluorinated alkyl group was obtained in the same manner as in Example 1 except that 0.06 g of hexyltrimethoxysilane (the following structural formula (3), manufactured by Tokyo Chemical Industry Co., Ltd.) was used instead of 0.15 g of trimethoxy (1H, 1H, 2H, 2H-tridecafluoro-n-octyl) silane.

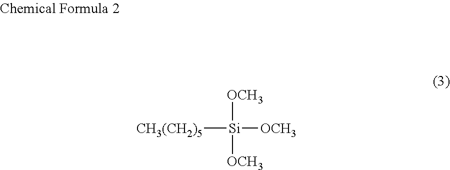

### Production of Solid Electrolyte Material

A solid electrolyte material was obtained in the same manner as in Example 1 except that the surface-modified SiO₂ (3) was used instead of the surface-modified SiO₂ (1).

### Measurement of Lithium Ionic Transport Number

The lithium ionic transport number of each of the solid electrolyte materials of Examples 1 and 2 and Comparative Examples 1 to 3 obtained above was measured in the following manner.

First, the solid electrolyte material was heated to 60° C. and a polypropylene separator was impregnated therewith. Then, a coin cell was produced using the separator impregnated with the solid electrolyte material so as to have a structure of Li metal/impregnated separator/Li metal. The produced coin cell was left to stand in a thermostat bath at 50° C. for 12 hours.

After still standing, alternating-current impedance measurement was performed using a potentiostat/galvanostat (VMP3, manufactured by Biologic) at 50° C. in a frequency range of 1 Hz to 1 MHz. A resistance measured at this time was defined as an impedance before polarization R₀ (Ω).

Then, direct-current polarization measurement was performed at 10 mV for 3600 seconds. An initial current value at this time was defined as a current value before polarization I₀ (A), and a current value in a steady state (after 3600 seconds) was defined as a current value after polarization Iₛ (A).

Further, alternating-current impedance measurement was performed in the frequency range of 1 Hz to 1 MHz. A resistance measured at this time was defined as an impedance after polarization Rₛ (Ω).

A lithium ionic transport number t_{Li+} was obtained by the following formula using the obtained values. In the following formula, V is an applied voltage (V). The results are shown in Table 1.

$${t}_{Li +} = \frac{{I}_{s} \times ( V - {I}_{0} \times {R}_{0} )}{{I}_{0} \times ( V - {I}_{s} \times {R}_{s} )} \qquad Formula 1$$

TABLE 1

| | Lithium Ionic Transport |
|---|---|
| | Number |
| Example 1 | 0.53 |
| Example 2 | 0.54 |
| Comparative Example 1 | 0.43 |
| Comparative Example 2 | 0.47 |
| Comparative Example 3 | 0.41 |

As shown in Table 1, the solid electrolyte materials of Examples 1 and 2 using the inorganic filler (SiO₂) surface-modified with a fluorinated alkyl exhibited a higher lithium ionic transport number than all the solid electrolyte material of Comparative Example 1 using no inorganic filler (SiO₂), the solid electrolyte material of Comparative Example 2 using the non-surface-modified inorganic filler (SiO₂), and the solid electrolyte material of Comparative Example 3 using the inorganic filler (SiO₂) surface-modified with a non-fluorinated alkyl group.

What is claimed is:

1. A solid electrolyte material comprising:
an Li salt having a fluorine-containing anion;
an inorganic filler; and
a polymer, wherein the inorganic filler has a surface modified with a fluorinated alkyl.

2. The solid electrolyte material according to claim 1, further comprising succinonitrile.

3. The solid electrolyte material according to claim 1, wherein:
the inorganic filler contains at least one selected from the group consisting of SiO₂, TiO₂, ZrO₂, and MgO; and
the fluorinated alkyl contains at least one of a 1H, 1H, 2H, 2H-tridecafluoro-n-octyl group and a 1H, 1H, 2H, 2H-heptadecafluorodecyl group.

4. The solid electrolyte material according to claim 1, wherein the Li salt contains at least one selected from the group consisting of lithium bis(fluorosulfonyl)imide (LiFSI), lithium bis(trifluoromethanesulfonyl)imide (LiTFSI), lithium bis(pentafluoroethanesulfonyl)imide (LiBETI), lithium fluorosulfonyl(trifluoromethanesulfonyl)imide (LiFTFSI), LiPF₆, LiBF₄, and LiCF₃SO₃ (LiTfO).

5. A battery comprising:
a positive electrode layer;
a negative electrode layer; and
an electrolyte layer, wherein:
the electrolyte layer contains a solid electrolyte; and
the solid electrolyte is the solid electrolyte material according to claim 1.
